(19) United States
(12) Patent Application Publication
(10) Pub. No.: US 2018/0221798 A1
(43) Pub. Date: Aug. 9, 2018

(54) Liquid Filter Insert and Liquid Filter with Corrosion Protection for External Pumps

(71) Applicant: MANN+HUMMEL GmbH, Ludwigsburg (DE)

(72) Inventors: Jonas Eble, Erlenbach (DE); Lars Spelter, Ditzingen (DE); Christoph Baumann, Moeglingen (DE)

(21) Appl. No.: 15/890,689

(22) Filed: Feb. 7, 2018

(30) Foreign Application Priority Data
Feb. 7, 2017 (DE) 10 2017 001 099.4

(51) Int. Cl. B01D 35/31; B01D 29/88; B01D 36/00; F02M 37/22; B01D 17/04

(52) U.S. Cl. CPC B01D 35/31; B01D 29/88; B01D 36/008; F02M 2037/225; B01D 17/045; B01D 2201/34; F02M 37/221

(57) ABSTRACT

A liquid filter insert for a liquid filter has a prefilter element and a main filter element connected to the prefilter element. Prefilter element and main filter element are arranged on top of each other in an axial direction relative to a longitudinal axis of the liquid filter insert. A connection provides a flow path for liquid to flow from the prefilter element to the main filter element. The prefilter element is provided with a water separation unit and is further provided with a filter medium. The water separation unit is arranged between the filter medium of the prefilter element and the connection such that the liquid, after passing through the filter medium, flows through the water separation unit into the connection. The water separation unit has a water discharge channel for water separated from the liquid that extends axially at least partially through the main filter element.

### TECHNICAL FIELD

The invention concerns a liquid filter insert for a liquid filter by means of which corrosion damages of pumps caused by water can be avoided and water can be reliably separated from the liquid to be filtered.

### BACKGROUND OF THE INVENTION

US 2008/0135469 A1 discloses a liquid filter system in the form of a fuel filter system in which a first particle filter is fluidically arranged upstream of a second particle filter. The first particle filter provides also for a droplet formation of the water which is contained in the fuel. Between the first and the second particle filters, a material is arranged through which the water droplets cannot pass. The water droplets move along the material to a collecting container. Disadvantageously, the first particle filter at the same time serves as a coalescing element which limits the choice of materials for this particle filter.

DE 10 2009 025 393 A1 discloses a liquid filter in the form of a fuel filter which comprises a coalescing element, a prefilter element fluidically arranged downstream thereof, and a main filter element fluidically arranged downstream of the prefilter element. The coalescing element, the prefilter element, and the main filter element are arranged along a common central tube. Disadvantageously, this filter system has a large size due to the separate coalescing, prefilter, and main filter elements.

DE 10 2015 003 165 A1 discloses a liquid filter insert in the form of a fuel filter insert for a fuel filter, comprising a prefilter element and a main filter element, wherein the main filter element comprises a water separation unit for separating water contained in the fuel. The fuel in this context is generally pumped by a pump from the prefilter element to the main filter element. Disadvantageously, the fuel in this filter system contains a high quantity of water when it is flowing through the pump between prefilter element and main filter element. This can cause the material of the pump to be attacked and damaged. Moreover, the water is divided by the pump into small droplets which makes water separation more difficult.

### SUMMARY OF THE INVENTION

It is therefore the object of the invention to provide a compact liquid filter insert by means of which damages caused by water in a pump that is used for the aforementioned purpose can be prevented and which facilitates a reliable water separation and enables a simpler venting action. Object of the invention is moreover to provide a liquid filter with such a liquid filter insert.

The object is solved by a liquid filter insert characterized in that the water separation unit comprises a water discharge channel for the water separated from the liquid which is extending in axial direction at least partially through the main filter element.

The object is further solved by a liquid filter comprising a liquid filter housing and a liquid filter insert according to the invention wherein the connection comprises a pump connector.

Advantageous embodiments result from the respective dependent claims.

The liquid filter insert according to the invention for a liquid filter comprises a prefilter element and a main filter element which are arranged on top each other and connected to each other in an axial direction relative to the longitudinal axis of the liquid filter insert. Moreover, it comprises a connection by means of which the liquid can flow from the prefilter element to the main filter element, wherein the prefilter element comprises a water separation unit for separating water contained in the liquid and a filter medium. In this context, the water separation unit is arranged between the filter medium of the prefilter element and the connection in such a way that the liquid can flow from this filter medium through the water separation unit into the connection. The filter medium of the prefilter unit is thus fluidically connected to the water separation unit and the water separation unit, in turn, to the connection, in particular directly. The prefilter element and the main filter element can be connected in particular fixedly with each other.

The particle separation efficiency increases from the prefilter to the main filter. According to the invention, the prefilter serves for protecting the fuel conveying pump (low pressure) and the main filter serves for protecting the high pressure system (injection pump and injectors).

The prefilter extends also the service life of the main filter in that coarser particles are already filtered out by the prefilter and the downstream main filter therefore must handle only a reduced particle load compared to a liquid that is not prefiltered. The separation efficiency can be clearly described in this context by means of the finer pore structure of the filter medium of the main filter (main filter medium) in comparison to the filter medium of the prefilter (prefilter medium); also, in comparison to the prefilter medium, finer fibers are used in the main filter medium.

The arrangement according to the invention of the prefilter at the top relative to the main filter in the direction of the longitudinal axis of the liquid filter (in installation direction), in comparison to an arrangement of the prefilter below the main filter in direction of the longitudinal axis of the liquid filter, has the advantage of improved and simpler venting action and of a reliable fast engine start. The sucked-in air or air that is produced by offgasing collects in the upper part of the housing and can be discharged constructively in a simple way through the central venting element. This makes it possible to maintain the housing free of air cushions as much as possible and to thus ensure a fast engine start. When the main filter is positioned at the bottom, the pressure that is available in the system pushes the remaining air to the vent due to the construction. At the pressure side, already less air is produced as a result of the system (no offgasing due to vacuum) and only little air is also conveyed from this part of the system in case of good venting of the prefilter. When the prefilter is however at the bottom relative to the main filter, the venting action is more difficult.

Advantageously, the water can be separated from the liquid already before it is pumped to the main filter. In this way, possible corrosion damages of the pump, which pumps the liquid in the liquid filter according to DE 10 2015 003 165 A1 from the prefilter to the main filter, are avoided. Moreover, the arrangement of the water separation unit at the prefilter provides for a more compact construction of the liquid filter insert in comparison to an arrangement thereof at the main filter.

An advantageous embodiment of the liquid filter insert is characterized in that the water separation unit comprises a water discharge channel for the water separated from the liquid which extends in axial direction at least partially through the main filter element.

In the operating state of the liquid filter insert, the prefilter element is preferably arranged above the main filter element so that a particularly compact configuration of the liquid filter insert can be achieved.

Advantageously, the water can be discharged, separate from the liquid, through the water discharge channel immediately downstream of the water separation unit. In this way, mixing is prevented after passing through the water separation unit.

A liquid filter according to the invention is characterized in that it comprises a liquid filter housing and a liquid filter insert according to the invention disposed in the liquid filter housing. In this context, the connection comprises in particular a pump connector. In this way, advantageously a pump can be connected in order to pump liquid through the liquid filter.

An advantageous embodiment of the liquid filter according to the invention is characterized in that the liquid filter housing comprises a liquid channel which is connected fluidically to the pump connector. In this way, the liquid, after separation from the water, can be advantageously conducted in a simple way out of the liquid filter housing for further use and supplied to a pump.

An advantageous embodiment of the liquid filter according to the invention is characterized in that the pump connector is connected to a pump of the liquid filter, wherein the pump is furthermore fluidically connected to the main filter element. By means of such a fluidic connection, the liquid can be advantageously conducted by the pump under pressure to the main filter element. In this case, regarding the prefilter element that comprises the water separation unit and a filter medium, the water separator is optimally designed to meet the conditions at the suction side.

The connection described above can therefore be comprised of several components. In particular, the connection can comprise the liquid channel, at least a pump connector and/or a hose in order to fluidically connect the prefilter element with the main filter element.

A further embodiment of the liquid filter according to the invention is characterized in that the liquid filter is embodied in the form of a fuel filter.

A further embodiment of the liquid filter according to the invention is characterized in that the liquid filter is embodied in the form of an oil filter.

### BRIEF DESCRIPTION OF THE DRAWINGS

Further features and advantages of the invention result from the following detailed description of an embodiment of the invention, from the claims as well as the Figures of the drawing that show details important to the invention. The different features can be realized individually or several combined in any combination in variants of the invention. The features illustrated in the drawing are shown such that the particularities according to the invention are made clearly visible.

FIG. 1 shows a liquid filter with a liquid filter housing and a filter insert arranged therein with a prefilter element and a main filter element in an isometric section illustration.

FIG. 2 shows the liquid filter of FIG. 1 in a longitudinal section.

FIG. 3 shows the filter insert of FIG. 1 in an individualized section illustration.

### DETAILED DESCRIPTION OF THE DRAWINGS

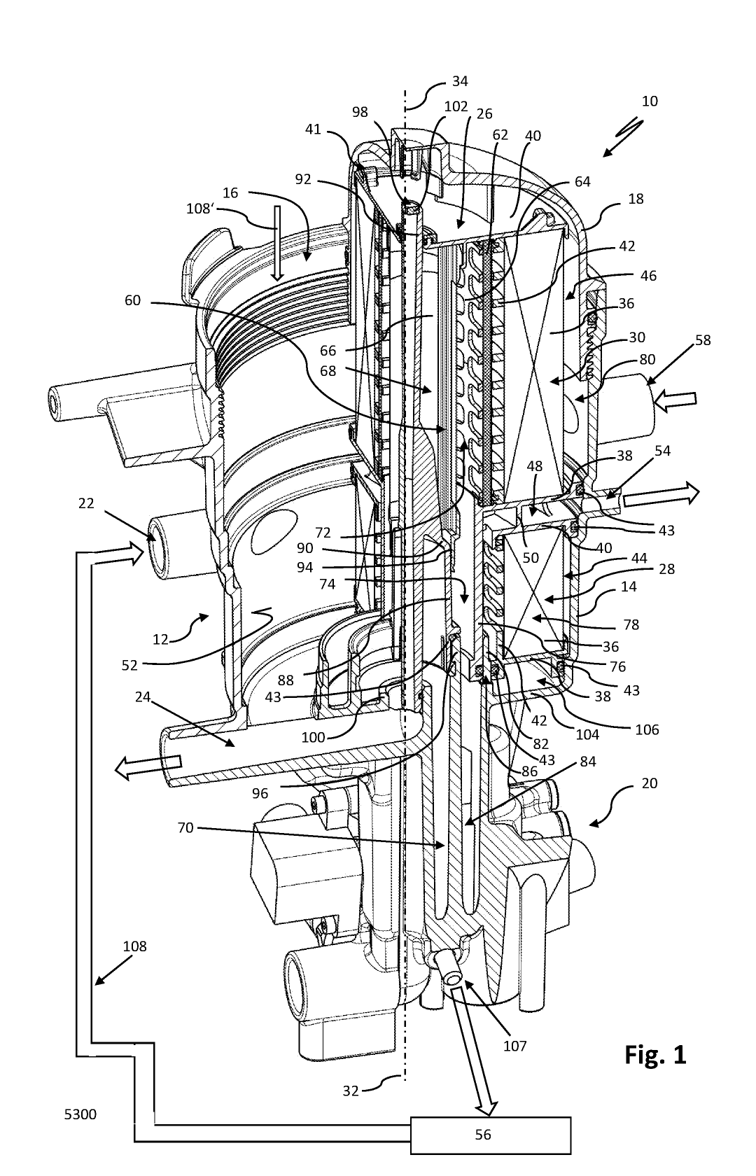

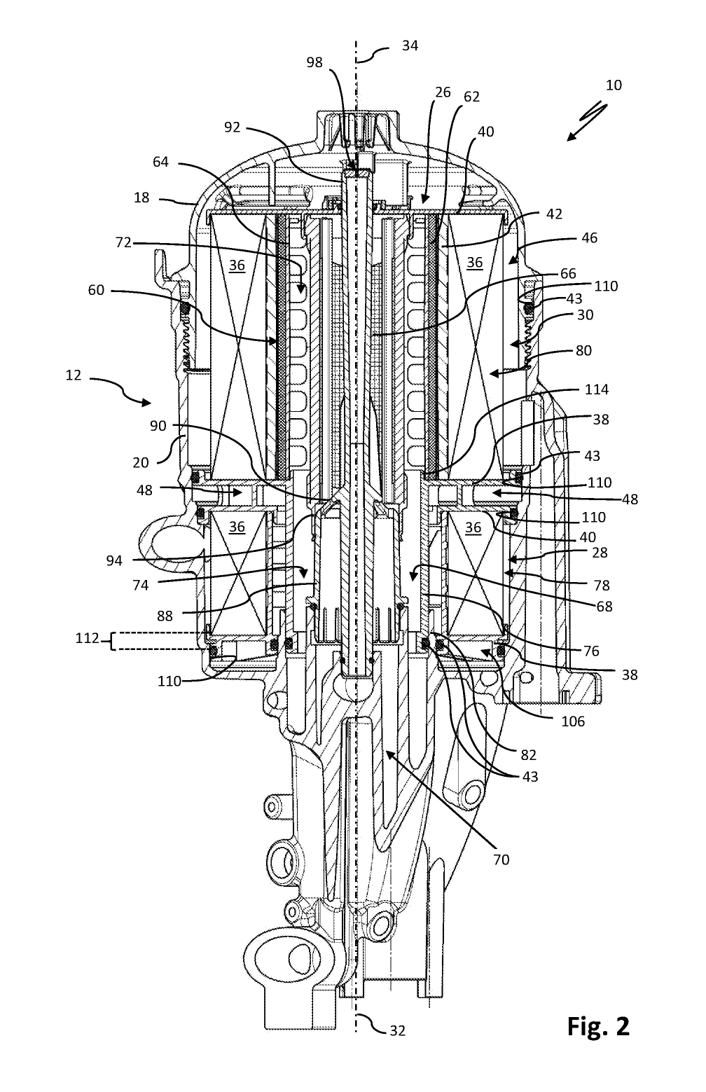

In FIGS. 1 and 2, a liquid filter 10 for filtering out contaminants contained in a liquid, in particular diesel fuel, is illustrated. The liquid filter 10 is suitable, for example, for use in commercial vehicles with internal combustion engine.

The liquid filter 10 comprises an openable liquid filter housing 12 with a filter pot 14 with an insertion opening 16 and with a housing cover 18 for closing off the filter pot 14. The housing cover 18 can be screwed into the filter pot 14. A different type of fastening of the housing cover 18 to the filter pot 14 is conceivable. The liquid filter housing 12 can be comprised, for example, of metal or of a plastic material. At the bottom end of the liquid filter housing 12, a so-called filter head 20 is formed. The liquid filter 10 is thus designed in a generally known manner for an upright arrangement in operation.

The liquid filter housing 12 comprises a liquid inlet 58 which serves for supply of the liquid to be filtered to the liquid filter 10. A liquid return 24 of the liquid filter housing serves for returning contaminated liquid, for example, to the aforementioned liquid tank.

A liquid filter insert 26 is arranged in the interior of the liquid filter housing 12. The liquid filter insert 26 comprises a main filter element 28 and a prefilter element 30. The two filter elements 28, 30 are arranged in the direction of the longitudinal axis 32 of the liquid filter 10 on top of each other in the liquid filter housing 12. The longitudinal axis 32 of the liquid filter 10 coincides with the longitudinal axis 34 of the liquid filter insert 26. The main filter element 28 is fluidically arranged downstream of the prefilter 30. In other words, in the present case the liquid to be filtered flows in operation first through the prefilter element 30, which is arranged at the top in the liquid filter housing 12, and subsequently through the main filter element 28, which is arranged below the prefilter element 30.

The prefilter element 30 and the main filter element 28 are each designed as round filter elements with a filter medium 36 that is arranged in an annular shape relative to the longitudinal axis 34 of the liquid filter insert 26. The filter medium 36 of the prefilter element 30 as well as of the main filter element 28 can be flowed through by the liquid to be filtered in a radial direction relative to the longitudinal axis 34 of the main filter insert 26 from the exterior to the interior, respectively. The filter media 36 are each embodied as a star-shape folded filter bellows and secured between a top and a bottom end disks 38, 40 of the respective filter element 28, 30. The top end disk 40 of the prefilter element 30 can be releasably coupled or decoupled by means of a bayonet connection 41 with the housing cover 18. For radial inward support of the filter media 36 of the prefilter element 30 as well as of the main filter element 28, a grid-shaped support tube 42 is provided, respectively. The filter media 36 are resting inwardly against the respective support tube 42, preferably directly.

The end disks 38, 40 of the prefilter element 30 and of the main filter element 28 which are correlated with each other, i.e., the bottom end disk 38 of the prefilter element 30 and the top end disk 40 of the main filter element 28, are arranged spaced apart from each other in axial direction. These two end disks 38, 40 rest seal-tightly (fluid-tightly) against the inner side of the liquid filter housing 12 by means of sealing elements 43, respectively. The two end disks 38, 40 serve therefore as sealing disks by means of which the interior of the liquid filter housing 12 is divided in axial direction into a prefilter chamber 46 that contains the prefilter element 30 and into a main filter chamber 44 that contains the main filter element 28. Between the top end disk 40 of the main filter element 28 and the bottom end disk 38 of the prefilter element 30, an outlet channel 48 for the liquid that has been filtered by the prefilter element 30 and the main filter element 28 is arranged. The outlet channel 48 is directly delimited by the end disks 38, 40 of the prefilter and main filter elements 28, 30 in axial direction.

The top end disk 40 of the main filter element 28 and the bottom end disk 38 of the prefilter element 30 can be formed monolithic with each other and can be in particular embodied as an injection molded plastic part. As can be seen in FIGS. 1 and 2, spacer elements 50 which are integrally formed on the two end disks 38, 40, respectively, are arranged between the two end disks 38, 40.

The outlet channel 48 is substantially of an annular configuration and is fluidically connected in radial direction with the inner wall 52 of the liquid filter housing 12. The outlet end of the outlet channel 48 is fluidically connected with a laterally (radially) arranged liquid outlet 54 of the liquid filter housing 12. The liquid inlet 58 is arranged axially displaced relative to the liquid outlet 54 of the liquid filter housing 12.

The prefilter element 30 comprises a water separation unit 60 for separation of the water contained in the liquid. The water separation unit 60 comprises a coalescing medium 62 that is arranged in an annular shape about the longitudinal axis 34 of the liquid filter insert 26. The coalescing medium 62, as is shown in FIGS. 1 and 2, can be arranged in particular fluidically downstream of the filter medium 36 of the prefilter element 30. In this context, the coalescing medium 62 is advantageously resting inwardly against a central tube 64 so that it does not collapse when it is pressure-loaded in operation of the liquid filter 10. The central tube 64 is arranged inside the support tube 42 and coaxial to the longitudinal axis 34 of the liquid filter insert 26. The coalescing medium 62 is thus arranged between the central tube 64 and the support tube 42 of the filter medium 36 of the prefilter element 30. As needed, the coalescing medium 62 can be constructed as a single layer or as a multilayer configuration and, for example, can be comprised of a nonwoven.

As can be seen in FIGS. 1 and 2, a screen tube 66 is arranged inside the central tube 64. The screen tube 66 serves functionally as a final separator for the water contained in the liquid. The screen tube 66 is arranged so as to extend coaxially relative to the longitudinal axis 34 of the liquid filter insert 26. The interior of the screen tube 66 is fluidically in communication by means of a liquid discharge channel 68, which extends in axial direction partially through the main filter element 28, with a liquid channel 70 of the liquid filter housing 12. The liquid, which has been filtered by the prefilter element 30 and from water has been removed at least partially by the prefilter 30, flows in operation from the interior of the screen tube 66 through the liquid discharge channel 68 and the liquid channel 70 of the liquid filter housing 12 in downward direction out of the liquid filter insert 26.

A (liquid) pump 56 is connectable to the liquid channel 70. The pump 56 serves to pump the prefiltered liquid into the main filter chamber 44. This is done in order to push the prefiltered liquid through the filter medium 36 of the main filter element 28 and suck it through the prefilter element 30.

An annular water separation gap 72 is formed between the screen tube 66 and the coalescing medium 62 or the central tube 64. The water separation gap 72 is embodied open in downward direction and is connected fluidically with one end to a lengthwise extending water discharge channel 74.

At the bottom end disk 38 of the prefilter element 30, a substantially tubular wall element 76 is integrally formed which is extending in axial direction away from the bottom end disk 38 of the prefilter element 30 in the direction of the filter head 20, i.e., in downward direction. The wall element 76 extends in axial direction into the main filter element 28 to the level of the bottom end disk 38 of the main filter element 28. The wall element 76 delimits the main filter chamber 44 in radial direction inwardly and separates the latter relative to the water discharge channel 74 of the liquid filter insert 26. In other words, the water discharge channel 74 for the water that has been separated from the liquid is immediately delimited in radial direction outwardly by the tubular wall element 76.

In total, the wall element 76 thus separates a high-pressure area 78, comprising the main filter element 28, and a low-pressure area 80, comprising the prefilter element 30, of the liquid filter insert 26 from each other.

The water discharge channel 74 can extend in axial direction completely or partially through the main filter element 28 and is fluidically connected by a housing or water discharge socket 82 of the liquid filter housing 12 with a water discharge channel or water collecting chamber 84 of the liquid filter housing 12.

The tubular wall element 76 and the bottom end disk 38 of the main filter element 28 delimit together a sealing gap 86 into which the housing or water discharge socket 82 is seal-tightly projecting in axial direction. The wall element 76 is contacting by means of a sealing element 43 an inner side of the water discharge socket 82 and the bottom end disk 38 of the main filter element 28 is contacting seal-tightly by means of a further sealing element 43 an outer side of the water discharge socket 82. In this way, the low-pressure area with the prefilter chamber 46 or the water discharge channel 74 is sealed relative to the high-pressure area.

The water discharge channel 74 is delimited in radial direction inwardly by a tubular element 88. The tubular element 88 forms at the same time an outward boundary of the liquid discharge channel 68 in radial direction. The tubular element 88 is integrally connected with one end by means of a fenestrated (not shown) connecting section 90, which is extending at a slant relative to the longitudinal axis 34 of the liquid filter insert 26, to a centrally arranged venting tube 92 of the liquid filter 10. Alternatively, the tubular element 88 can also be embodied as a part of the screen tube 66 of the liquid filter insert 26.

A free end section of the screen tube 66 is formed as a sealing lip or as a sealing collar 94 and contacts seal-tightly the tubular element 88 externally about the entire circumference. The other end of the tubular element 88 of the venting tube 92, i.e., its bottom end, is locked with a liquid discharge socket 96 of the liquid filter housing 12 and rests seal-tightly against it on the inner side by means of a sealing element 43.

The venting tube 92 serves for venting the prefilter element 30 or the prefilter chamber 46 and extends coaxially to the longitudinal axis 34 of the liquid filter insert through the latter. At one end, the venting tube 92 can axially project with its inlet opening 98 past the top end disk 40 of the prefilter element 30. The inlet opening 98 of the venting tube 92 in this case is arranged between the top end disk 40 of the prefilter element 30 and the housing cover 18. It is understood that the venting tube 92 can also be arranged flush or substantially flush relative to the top end disk 40 of the main filter element 28. The venting tube 92 projects seal-tightly with the other end into a venting socket 100 of the liquid filter housing 12. The venting socket 100 can be fluidically connected with the liquid return 24 of the liquid filter housing 12. In operation of the liquid filter 10, air contained in the liquid or gases given off by the liquid in the area of the prefilter chamber 46 can thus be evacuated from the liquid filter housing 12 by means of the venting tube 92 and the liquid return 24 of the liquid filter housing 12. The venting tube 92 can be provided with a throttle 102 for safety reasons, for example, in the area of its inlet opening 98.

The main filter chamber 44 is delimited downwardly by a housing bottom 104 of the liquid filter housing 12. In the illustrated installed state, the main filter element 28 is arranged axially spaced apart from the housing bottom 104. In this way, a liquid discharge channel 106 is formed or defined between the bottom end disk 38 of the main filter element 28 and the housing bottom 104. The liquid discharge channel 106 surrounds the longitudinal axis 32 of the liquid filter housing 12 and is open toward, i.e., fluidically connected to, the liquid return 24 of the liquid filter housing 12.

The filter pot 14 comprises an inner cross section which tapers in a stepwise fashion axially in the direction toward the housing bottom 104, i.e., in insertion direction 108′ of the liquid filter insert 26. The liquid filter housing 12 comprises therefore in the area of its inner wall 52 sealing surface sections 110 (see FIG. 2) for sealing contact of the end disks 38, 40 of the liquid filter insert 26 which, with increasing distance from the insertion opening 16 of the liquid filter housing 12 in the direction toward the housing bottom 104, are spaced less far from the longitudinal axis 34 of the liquid filter insert 26. The sealing elements 43 of the bottom end disk 38 of the prefilter element 30 as well as of the two end disks 38, 40 of the main filter element 28 are differently spaced apart in a corresponding manner relative to the longitudinal axis 34 of the liquid filter insert 26 and are seal-tightly contacting the sealing surface sections 110 of the filter pot 14 in the illustrated operating position of the liquid filter insert 26 in the liquid filter housing 12. In this way, the liquid filter insert 26 can be inserted in a simplified way and without unnecessary overstressing of its sealing elements 43 into its operating position in the liquid filter housing 12.

For exchanging the liquid filter insert 26, it is moved opposite to the insertion direction 108′ axially out of the filter pot 14. As soon as the liquid filter insert 26 has been moved by an axial travel indicated by 112 (see FIG. 2) from its illustrated installed position into a drainage position, the sealing elements 43 of the bottom and top end disks 38, 40 of the main filter element 28 as well as of the bottom end disk 38 of the prefilter element 30 are removed from their respective sealing position at the liquid filter housing 12 or the water discharge socket 82. Accordingly, the prefilter chamber 46 is fluidically connected by means of the main filter chamber 44 with the liquid discharge channel 106. Following the force of gravity, the raw-side liquid can flow in this way from the prefilter chamber 46 through the main filter chamber 44, together with the liquid located therein at the raw side, into the liquid discharge channel 106. By means of the liquid discharge channel 106, the liquid can drain to the liquid return 24.

It should be noted that the axial length of the housing-associated water discharge socket 82 is dimensioned such that the sealing element 43 of the wall element 76 in the drainage position of the liquid filter insert 26 is still seal-tightly contacting the water discharge socket 82. In this way, it is ensured that the liquid from the main filter chamber 44 does not reach the water discharge (socket) or the liquid discharge socket 96 of the liquid channel 70.

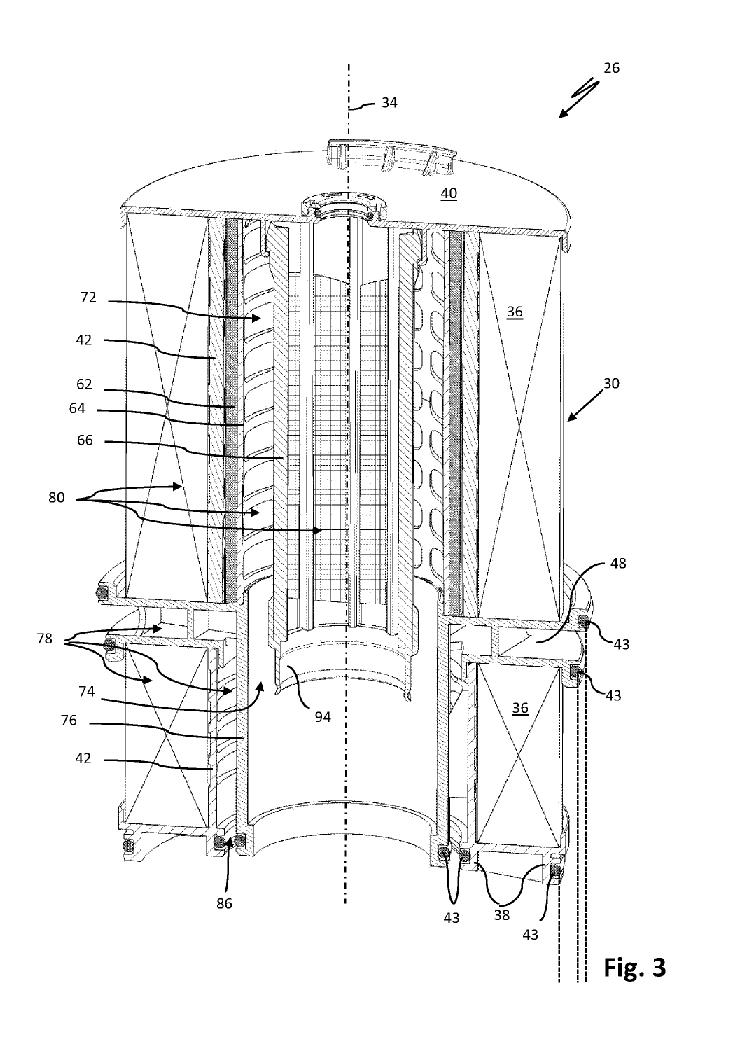

FIG. 3 shows the liquid filter insert of FIGS. 1 and 2 in an individualized illustration and in a longitudinal section. The grid structure of the screen tube 66 can be seen clearly in this illustration. The screen tube 66 is locked with the top end disk 40 of the prefilter element 30. The sealing collar 94 of the screen tube 66 can be comprised of an elastically deformable (plastic) material. Upon axially oriented insertion of the liquid filter insert 26 into the liquid filter housing 12 (FIGS. 1 and 2) with guiding action along the slantingly extending connecting section 90 of the venting tube 92, the sealing collar 94 can be pushed seal-tightly onto the tubular element 88 in this way. The bottom end disk 38 of the prefilter element 30 comprises on the inner circumference a securing stay 114 (see FIG. 2). The securing stay 114 projects from the bottom end disk 38 axially in the direction toward the top end disk 40 of the prefilter element 30 and supports the central tube 64 on the inner side.

In operation of the liquid filter 10 (see FIG. 1), the unfiltered liquid flows through the liquid inlet 58 of the liquid filter housing 12 into the prefilter chamber 46 and flows through the filter medium 36 of the prefilter element 30 in radial direction from the exterior to the interior. The prefiltered liquid flows through the coalescing medium 62 and the screen tube 66 in a radial direction relative to the longitudinal axis 34 of the liquid filter insert 26 from the exterior to the interior. Thereby, the water contained in the liquid is at least partially separated from the liquid and flows, following the force of gravity, from the water separation gap 72 through the water discharge channel 74 in downward direction into the water collecting chamber 84 of the liquid filter housing 12. The liquid, from which the contaminants have been removed in this way, flows out of the liquid filter 10 through the liquid channel 70 and a first pump connector 107 and is pumped by means of the pump 56, which is fluidically interposed, through a second pump connector 22 into the main filter chamber 44 of the liquid filter housing 12. Here, the liquid flows through the filter medium 36 of the main filter element 28 and flows subsequently into the flow channel 48. From here, it passes into the liquid outlet 54 of the liquid filter housing 12 and can be supplied to an internal combustion engine or a liquid injection pump.

The connection 108 that provides a flow path for the liquid comprises here the liquid channel 70, in particular the pump 56, the first pump connector 107, and the second pump connector 22.

For exchanging the liquid filter insert 26, in a first step the housing cover 18 is removed from the filter pot 14. The bayonet connection 41 between the housing cover 18 and the liquid filter insert 26 is closed or will be closed by the screwing movement of the housing cover 18. The liquid filter insert 26 as a whole is moved by the screwing movement axially in the direction of the longitudinal axis 32 of the liquid filter housing 12 out of its installation position (FIGS. 1 and 2). As soon as the liquid filter insert 26 is in the drainage position, the raw-side liquid flows out of the prefilter chamber 46 of the liquid filter housing 12 into the raw-side main filter chamber 44 and together with the raw-side liquid arranged therein through the liquid discharge channel 106 into the liquid return 24 as well as optionally into a liquid tank fluidically connected thereto. Upon further unscrewing or lifting off of the housing cover 18 from the filter pot 14 together with the liquid filter insert 26, also the inwardly positioned sealing element 43 of the wall element 76 as well as the sealing element 43 of the bottom end disk 38 of the main filter element 28 that is contacting the water discharge socket 82 are moved away from their seal-tight contact at the water discharge socket 82. A liquid level of a liquid/water mixture that is possibly present at the clean side can then flow radially in outward direction into the liquid discharge channel 106 and can drain through the liquid return 24 from the filter housing 12. After complete removal of the liquid filter insert 26 from the filter pot 14, the liquid filter insert 26 is removed from the housing cover 18 and a new liquid filter insert 26 is fastened to the housing cover 18. The liquid filter insert 26 is subsequently inserted in the insertion direction into the filter pot 14 and is transferred into its installation position (FIGS. 1 and 2) by tightly screwing the housing cover 18 onto the filter pot 14.

When looking at all Figures of the drawing, the invention in summary concerns a liquid filter insert 26. The liquid filter insert 26 according to the invention for a liquid filter 10 comprises a prefilter element 30 and a main filter element 28 which are arranged on top of each other in axial direction of the longitudinal axis 34 of the liquid filter insert 26. Moreover, it comprises a connection through which the liquid can flow from the prefilter element 30 to the main filter element 28, wherein the prefilter element 30 comprises a water separation unit 60 for separating water contained in the liquid and a filter medium 36. The water separation unit 60 is arranged between the filter medium 36 of the prefilter element 30 and the connection 108 in such a way that the liquid from the filter medium 36 of the prefilter element 30 can flow through the water separation unit 60 into the connection 108.

What is claimed is:

1. A liquid filter insert for a liquid filter, the liquid filter insert comprising:
a prefilter element;
a main filter element connected to the prefilter element, wherein the prefilter element and the main filter element are arranged on top of each other in an axial direction relative to a longitudinal axis of the liquid filter insert;
a connection providing a flow path for a liquid to flow from the prefilter element to the main filter element;
the prefilter element comprising a water separation unit configured to separate water contained in the liquid;
the prefilter element comprising a filter medium;
the water separation unit arranged between the filter medium of the prefilter element and the connection such that the liquid, after passing through the filter medium, flows through the water separation unit into the connection;
the water separation unit comprising a water discharge channel for water separated from the liquid, the water discharge channel extending in the axial direction at least partially through the main filter element.

2. The liquid filter insert according to claim 1, wherein the prefilter element in a mounted state of the liquid filter insert is arranged above the main filter element.

3. A liquid filter comprising a liquid filter housing and further comprising a liquid filter insert configured to be mounted in the liquid filter housing, wherein the liquid filter insert comprises:
a prefilter element and a main filter element connected to the prefilter element, wherein the prefilter element and the main filter element are arranged on top of each other in an axial direction relative to a longitudinal axis of the liquid filter insert;
a connection providing a flow path for a liquid to flow from the prefilter element to the main filter element;
the prefilter element comprising a water separation unit configured to separate water contained in the liquid;
the prefilter element comprising a filter medium;
the water separation unit arranged between the filter medium of the prefilter element and the connection such that the liquid after passing through the filter medium flows through the water separation unit into the connection;
the water separation unit comprising a water discharge channel for water separated from the liquid, the water discharge channel extending in the axial direction at least partially through the main filter element:
the connection comprising a pump connector.

4. The liquid filter according to claim 3, wherein the liquid filter housing comprises a liquid channel fluidically connected to the pump connector.

5. The liquid filter according to claim 3, further comprising a pump, whereon the pump connector is connected to the pump, wherein the pump is fluidically connected to the main filter element.

6. The liquid filter according to claim 3, wherein the liquid filter is a fuel filter.

7. The liquid filter according to claim 3, wherein the liquid filter is an oil filter.
